(19) United States
(12) Patent Application Publication
(10) Pub. No.: US 2026/0340453 A1
(43) Pub. Date: Oct. 29, 2026

(54) LARGE LANGUAGE MODEL INFERENCE

(71) Applicant: SCITIX (SGP) TECH PTE. LTD., Singapore (SG)

(72) Inventors: Yongchao He, Singapore (SG); Bohan Zhao, Singapore (SG)

(21) Appl. No.: 19/255,331

(22) Filed: Jun. 30, 2025

(30) Foreign Application Priority Data
Apr. 29, 2025 (CN) 202510551114.3

(51) Int. Cl. G06N 5/04

(52) U.S. Cl. CPC G06N 5/04

(57) ABSTRACT

A method and an apparatus for large language model inference, a device, and a medium are provided. The method includes: performing, by a CPU and a GPU collaboratively, a plurality of iterations, each iteration including: a first task performed by the CPU, including determining a plurality of unfinished sequences and latest generated token IDs for the sequences; a second task performed by the CPU, including generating a model input; a third task performed by the GPU, including computing probability distributions of next tokens to be generated for the sequences; a fourth task performed by the GPU, including sampling from the probability distributions to obtain IDs of the next tokens; and a fifth task performed by the CPU, including updating completion states of the sequences, where an (n+1)^{th} iteration and an n^{th} iteration are performed asynchronously.

### CROSS REFERENCE TO RELATED APPLICATIONS

This application claims priority to Chinese Patent Application No. 202510551114.3, filed on Apr. 29, 2025, the contents of which are hereby incorporated by reference in its entirety for all purposes.

### TECHNICAL FIELD

The present disclosure relates to the technical field of artificial intelligence, and in particular to a method and apparatus for large language model inference, a device, and a medium.

### BACKGROUND

In recent years, artificial intelligence models have seen exponential growth in terms of scale and number of parameters. Large language models (LLMs) have been widely applied in question answering, code generation, content creation and other scenarios. As model sizes continue to expand, the requirements for computing resources, response latency, and throughput capacity in the inference phase have correspondingly increased. In the industry, widespread attention has been paid to how to further reduce inference costs and improve overall performance while maintaining generation quality, enabling real-time interaction and large-scale deployment.

### SUMMARY

According to an aspect of the present disclosure, there is provided a method. The method includes: performing, by at least one CPU and at least one GPU collaboratively, a plurality of iterations of LLM inference process, wherein each iteration of the plurality of iterations includes the following tasks performed in sequence: a first task performed by the at least one CPU, the first task including determining a plurality of unfinished sequences and latest generated token IDs of the plurality of unfinished sequences; a second task performed by the at least one CPU, the second task including generating a model input based on the latest generated token IDs of the plurality of unfinished sequences; a third task performed by the at least one GPU, the third task including computing, based on the model input, probability distributions for a plurality of next tokens to be generated for the plurality of unfinished sequences; a fourth task performed by the at least one GPU, the fourth task including sampling from the probability distributions for the plurality of next tokens to obtain token IDs for the plurality of next tokens; and a fifth task performed on the at least one CPU, the fifth task including updating, based on the token IDs for the plurality of next tokens, completion states of the plurality of unfinished sequences, where an (n+1)^{th} iteration and an n^{th} iteration are performed asynchronously, a first task and a second task of the (n+1)^{th} iteration are performed in parallel with a third task of the nth iteration, and a third task of the (n+1)^{th} iteration is performed in parallel with a fifth task of the nth iteration.

According to another aspect of the present disclosure, there is provided an apparatus, configured to use at least one CPU and at least one GPU collaboratively to perform a plurality of iterations of LLM inference, where each iteration of the plurality of iterations includes a first task, a second task, a third task, a fourth task, and a fifth task performed in sequence. The apparatus includes: a first processing unit configured to perform the first task on the at least one CPU, the first task including determining a plurality of unfinished sequences and latest generated token IDs of the plurality of unfinished sequences; a second processing unit configured to perform the second task on the at least one CPU, the second task including generating a model input based on the latest generated token IDs of the plurality of unfinished sequences; a third processing unit configured to perform the third task on the at least one GPU, the third task including computing, based on the model input, probability distributions for a plurality of next tokens to be generated for the plurality of unfinished sequences; a fourth processing unit configured to perform the fourth task on the at least one GPU, the fourth task including sampling from the probability distributions of the plurality of next tokens to obtain token IDs for the plurality of next tokens; and a fifth processing unit configured to perform the fifth task on the at least one CPU, the fifth task including updating, based on the token IDs for the plurality of next tokens, completion states of the plurality of unfinished sequences, where an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.

According to still another aspect of the present disclosure, there is provided an electronic device, comprising: at least one CPU and at least one GPU; a memory storing one or more programs configured to be executed by the at least one CPU and at least one GPU, collaboratively, the one or more programs including instructions for performing a plurality of iterations of LLM inference, wherein each iteration of the plurality of iterations comprises the following tasks performed in sequence: a first task performed by the at least one CPU, the first task comprising determining a plurality of unfinished sequences and latest generated token IDs of the plurality of unfinished sequences; a second task performed by the at least one CPU, the second task comprising generating a model input based on the latest generated token IDs of the plurality of unfinished sequences; a third task performed by the at least one GPU, the third task comprising computing, based on the model input, probability distributions for a plurality of next tokens to be generated for the plurality of unfinished sequences; a fourth task performed by the at least one GPU, the fourth task comprising sampling from the probability distributions for the plurality of next tokens to obtain token IDs for the plurality of next tokens; and a fifth task performed by the at least one CPU, the fifth task comprising updating, based on the token IDs for the plurality of next tokens, completion states of the plurality of unfinished sequences, wherein an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.

According to still another aspect of the present disclosure, there is provided a computer device, including: at least one processor; and a memory having a computer program stored thereon, where the computer program, when executed by the processor, causes the processor to perform the method described above.

According to yet another aspect of the present disclosure, there is provided a non-transient computer-readable storage medium storing one or more programs, the one or more programs comprising instructions, which when executed by at least one CPU and at least one GPU of an electronic device, collaboratively, cause the electronic device to: perform a plurality of iterations of large language model (LLM) inference, wherein each iteration of the plurality of iterations comprises the following tasks performed in sequence: a first task performed by the at least one CPU, the first task comprising determining a plurality of unfinished sequences and latest generated token IDs of the plurality of unfinished sequences; a second task performed by the at least one CPU, the second task comprising generating a model input based on the latest generated token IDs of the plurality of unfinished sequences; a third task performed by the at least one GPU, the third task comprising computing, based on the model input, probability distributions for a plurality of next tokens to be generated for the plurality of unfinished sequences; a fourth task performed by the at least one GPU, the fourth task comprising sampling from the probability distributions for the plurality of next tokens to obtain token IDs for the plurality of next tokens; and a fifth task performed by the at least one CPU, the fifth task comprising updating, based on the token IDs for the plurality of next tokens, completion states of the plurality of unfinished sequences, wherein an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.

According to yet still another aspect of the present disclosure, there is provided a computer program product including a computer program that, when executed by a processor, causes the processor to perform the method described above in the claims.

According to some embodiments, two adjacent iterations of LLM inference are interleaved in the present disclosure. While the GPU is still performing forward propagation computation and sampling (i.e., the third task and the fourth task) of the n^{th} iteration, the CPU has already completed, in parallel, model input preparation (i.e., the first task and the second task) for the next iteration, i.e. (n+1)^{th} iteration. The GPU's forward propagation computation (the third task) for the (n+1)^{th} iteration can be started after a communication between the CPU and the GPU. In this way, all CPU-side overheads are completely hidden within the GPU's computation window, eliminating the mutual wait between sequential performing of adjacent iterations typically in conventional methods, thereby reducing inference latency per iteration and improving the overall throughput.

These and other aspects of the present disclosure will be apparent from the embodiments described below, and will be clarified with reference to the embodiments described below.

### BRIEF DESCRIPTION OF THE DRAWINGS

More details, features and advantages of the present disclosure are disclosed in the following description of example embodiments with reference to the accompanying drawings, in which:

FIG. 1 is a schematic diagram illustrating an example system in which various methods described herein may be implemented according to an example embodiment;

FIG. 2 is a flowchart illustrating a method for large language model inference according to an example embodiment;

FIG. 3 is a schematic diagram illustrating data and resource dependencies within a single iteration and between adjacent iterations during LLM inference according to an example embodiment;

FIG. 4 is a schematic diagram illustrating LLM inference of asynchronously performing iterations according to an example embodiment;

FIG. 5 is a schematic diagram illustrating input processing according to an example embodiment;

FIG. 6 is a schematic diagram illustrating a parallel sampling process according to an example embodiment;

FIG. 7 is a schematic diagram illustrating LLM inference according to an example embodiment;

FIG. 8 is a schematic diagram illustrating a comparison of performance between the solution of the present disclosure according to an example embodiment and the related art;

FIG. 9 is a schematic diagram illustrating a comparison of performance between the solution of the present disclosure according to an example embodiment and the related art;

FIG. 10 is a structural block diagram illustrating an apparatus for large language model inference according to an example embodiment; and

FIG. 11 is a block diagram illustrating an example computer device that can be applied to an example embodiment.

### DETAILED DESCRIPTION OF THE EMBODIMENTS

In the present disclosure, unless otherwise stated, the terms “first”, “second”, etc., used to describe various elements are not intended to limit the positional, temporal or importance relationship of these elements, but rather only to distinguish one component from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. As used herein, the term “plurality of” means two or more, and the term “based on” should be interpreted as “at least partially based on”. Moreover, the terms “and/or” and “at least one of . . . ” encompass any one of and all possible combinations of the listed items.

Before describing the example embodiments of the present disclosure, several terms used herein are first explained.

In large language model (LLM) inference, an inference engine (e.g., vLLM) calls a trained model to generate an output based on a prompt (for example, a user input). Prior to inference, the prompt is segmented into smaller units (e.g., tokens), which are then mapped to token IDs by a tokenizer (e.g., byte pair encoding or SentencePiece). In the present disclosure, the term “sequence” refers to an ordered list of token IDs, including both the prompt and output generated based on it. In addition, unless otherwise specified, the terms such as a model and a large model in the present disclosure refer to the large language model (LLM). Before a complete output is produced, the sequence needs to go through two stages: a prefill stage and a decode stage.

Prefill: In the prefill stage, a model processes all prompt token IDs in a sequence (i.e., the prompt text) through one or more batches of forward propagation processes in one or more iterations of LLM inference, and generates probability distributions for all prompt token IDs. Decode: In the decode stage, the model generates a new token ID in an iterative manner based on the prompt token ID and one or more previously generated output token IDs. In some embodiments, a next token ID may be predicted through a probability distribution computation using a softmax function. The inference engine may adopt a strategy such as greedy sampling to select the next token ID (referred to as a sampled token ID or sampled result) and append the sampled token ID to the sequence. This process is repeated until a stop condition is met.

Parallel Inference: A parallel inference system launches a plurality of worker processes (where each worker process may correspond to a specific GPU) to deploy the same model for inference on a plurality of GPUs. A scheduler may run on a master process (for example, the first one of all the worker processes) and is responsible for distributing requests, gathering outputs, and allocating computational loads to other worker processes, thereby enabling parallel GPU execution.

Iteration: In LLM inference, an iteration is a token generation process performed in the decode stage, or a forward propagation computation process performed on a portion or all prompt token IDs in the prefill stage.

Example embodiments of the present disclosure are described in detail below with reference to the drawings.

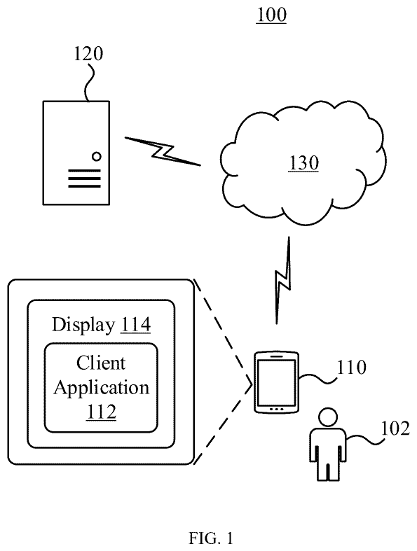

FIG. 1 is a schematic diagram illustrating an example system 100 in which various methods described herein may be implemented according to an example embodiment.

Referring to FIG. 1, the system 100 includes a client device 110, a server 120, and a network 130 that communicatively couples the client device 110 to the server 120.

The client device 110 includes a display 114 and a client application (APP) 112 that can be displayed via the display 114. The client application 112 may be an application program that needs to be downloaded and installed before running, or a liteapp that is a lightweight application program. In the case where the client application 112 is an application program that needs to be downloaded and installed before running, the client application 112 may be pre-installed on the client device 110 and activated. In the case where the client application 112 is a liteapp, a user 102 may run the client application 112 directly on the client device 110 by searching for the client application 112 in a host application (for example, by the name of the client application 112, etc.) or scanning a graphic code (for example, a bar code, a two-dimensional code, etc.) of the client application 112, without installing the client application 112. In some embodiments, the client device 110 may be any type of mobile computer device, including a mobile computer, a mobile phone, a wearable computer device (for example, a smart watch, a head-mounted device including smart glasses, etc.), or other types of mobile devices. In some embodiments, the client device 110 may alternatively be a stationary computer device, such as a desktop computer, a server computer, or other types of stationary computer devices.

The server 120 is typically deployed by an Internet service provider (ISP) or an Internet content provider (ICP). The server 120 may be a single server, a cluster of a plurality of servers, a distributed system, or a cloud server providing basic cloud services (such as a cloud database, cloud computing, cloud storage, cloud communication). It is to be understood that although FIG. 1 shows that the server 120 communicates with only one client device system 110, the server 120 can provide backend services for a plurality of client devices at a time.

Examples of the network 130 include a combination of a local area network (LAN), a wide area network (WAN), a personal area network (PAN), and/or a communication network such as the Internet. The network 130 may be a wired or wireless network. In some embodiments, data exchanged over the network 130 is processed using technologies and/or formats including HyperText Markup Language (HTML), Extensible Markup Language (XML), etc. In addition, all or some links may be encrypted using encryption technologies such as Secure Sockets Layer (SSL), Transport Layer Security (TLS), a virtual private network (VPN), Internet Protocol Security (IPsec), etc. In some embodiments, the above data communication technologies may also be replaced or supplemented with customized and/or dedicated data communication technologies.

For the purpose of the embodiments of the present disclosure, in the example of FIG. 1, the client application 112 may be an electronic map application program, which can provide various functions based on an electronic map, such as navigation, route query, and location search. Correspondingly, the server 120 may be a server for use with the electronic map application program. Based on road network data, the server 120 may provide, to the client application 112 running in the client device 110, online map services, such as online navigation, online route query, and online location search. Alternatively, the server 120 may also provide the road network data to the client device 110, allowing the client application 112 running in the client device 110 to provide a local map service based on the road network data.

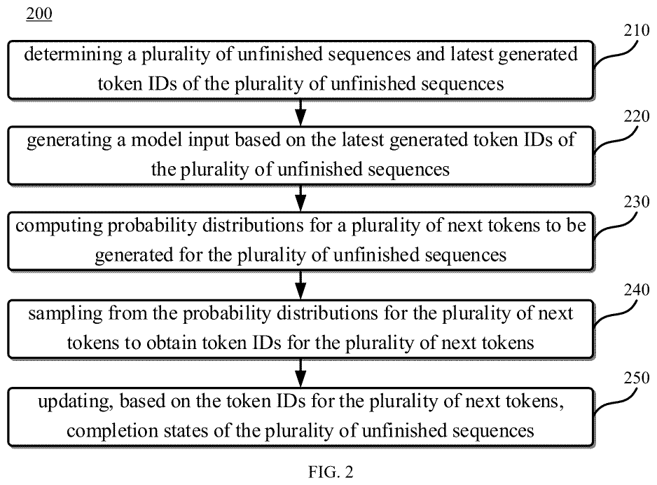

FIG. 2 is a flowchart illustrating an inference method 200 for large language model inference according to an example embodiment. The inference method 200 includes performing, by at least one CPU and at least one GPU collaboratively, a plurality of iterations of LLM inference. Each iteration includes a first task, a second task, a third task, a fourth task, and a fifth task that are performed in sequence.

The method 200 may be performed at a client device (for example, the client device 110 shown in FIG. 1), that is, an execution body of steps of the method 200 may be the client device 110 shown in FIG. 1. In some embodiments, the method 200 may be performed at a server (for example, the server 120 shown in FIG. 1). In some embodiments, the method 200 may be performed by the client device (for example, the client device 110) and the server (for example, the server 120) in combination. In the following, taking the execution body as the client device 110 as an example, detailed description of the tasks executed in the method 200 is provided.

The at least one GPU used in the inference method of the present disclosure may be a single GPU card or a GPU cluster, which may include a plurality of worker processes (or worker nodes), with each worker process corresponding to one GPU card.

The at least one CPU used in the inference method of the present disclosure may be a single CPU processor or a plurality of CPU processors, which may include CPU processors associated with each of the plurality of worker processes.

Referring to FIG. 2, the first task 210 is performed on the at least one CPU, and includes determining a plurality of unfinished sequences and latest generated token IDs for the plurality of unfinished sequences. The first task may alternatively be defined as being configured to determine, on the at least one CPU, the plurality of unfinished sequences and the latest generated token IDs for the plurality of unfinished sequences.

The first task may also be referred to as a scheduling task (Scheduling, T₁). Current inference frameworks typically adopt a scheduling strategy referred to as iteration batching. At the start of each iteration, a portion of unfinished sequences of all unfinished sequences may be selected based on a priority strategy (such as LRU in SGLang or FCFS in vLLM), and scheduling outputs may be generated. For the selected sequences (i.e., the plurality of unfinished sequences), the inference process is completed collaboratively at the CPU and the GPU in the current iteration. At the end of each iteration, completed sequences are removed and new sequences are added, thereby minimizing the waiting time for sequences to be processed.

In some embodiments, each sequence provided for scheduling maintains a completion state, which indicates whether the LLM inference for the sequence is finished. It may be understood that an “unfinished sequence” refers to one for which the LLM inference is not finished yet. In an example, an unfinished sequence may be a sequence for which an end tag such as <EOS> has not yet been generated. In the present disclosure, an unfinished sequence determined in the first task of an iteration is also denoted as an unfinished sequence scheduled in this iteration.

In some embodiments, the aforementioned scheduling process of the first task may be implemented by a scheduler thread running on the at least one CPU.

In some embodiments, the scheduling outputs (i.e., processing results of the first task) may include latest generated token IDs for the plurality of unfinished sequences, and may also include the number of the plurality of unfinished sequences, prompt lengths, generated lengths, and other information of the sequences.

According to some embodiments, the plurality of unfinished sequences may include a plurality of prefilling sequences in the prefill stage and a plurality of decoding sequences in the decode stage. Since the prefilling stage does not require the generation of the token IDs, the latest generated token IDs for the plurality of unfinished sequences are associated with the plurality of decoding sequences. That is to say, the latest generated token IDs include, for each decoding sequence, a respective latest generated token ID. However, the prefill stage still requires inference to compute probability distributions for token IDs in a prompt. The first task may include: determining, for each prefilling sequence, one or more prompt token IDs to be processed in the current iteration.

In some embodiments, for the prefilling sequence, all token IDs corresponding to the prompt or a portion of the prompt token IDs may be provided to the model in a single iteration, as will be described below.

The second task 220 is performed by the at least one CPU, and includes generating a model input based on the latest generated token IDs of the plurality of unfinished sequences. The second task may alternatively be defined as being configured to generate, on the at least one CPU, the model input.

The second task may also be referred to as an input processing task (Input Processing, T₂). The second task may include converting the scheduling outputs obtained in the first task into the model input. For example, a list of latest generated token IDs for unfinished sequences for which inference needs to be performed in the current iteration may be converted into a tensor, which is then transmitted to the GPU. In some embodiments, the second task may also include determining metadata required for LLM inference, such as the number of unfinished sequences for the current iteration, and control parameters (i.e., sampling metadata) required for a following sampling process. These metadata may also be transmitted to the GPU as a part of the model input. When tensor parallelism is used, the second task may further include broadcasting the determined metadata and the model input to all worker processes. In some embodiments, the second task may be implemented by an input processor thread running on the CPU.

The third task 230 is performed by the at least one GPU, and includes computing, based on the model input, probability distributions for a plurality of next tokens to be generated for the plurality of unfinished sequences. The third task may alternatively be defined as being configured to compute, on the at least one GPU, the probability distributions for the plurality of tokens.

The third task may also be referred to as a decoding forward propagation task (Decoding Forward, T₃). Once the model input is prepared and transmitted to the GPU, a trained model may be used to compute probability distributions for possible next tokens (i.e., output tokens) of the plurality of unfinished sequences (specifically, decoding sequences). As used herein, the term “probability distributions” may refer to either unnormalized token-level scores (e.g., logits) or normalized probabilities (e.g., values obtained by applying a softmax function to logits). In some embodiments, the third task outputs logits as unnormalized scores for possible next tokens, and these logits may be further processed in the fourth task to generate actual token samples. The third task may be performed in parallel on the at least one GPU. In some embodiments, a single GPU card may perform forward propagation computation for a plurality of unfinished sequences in parallel. In some embodiments, if the GPU includes a plurality of worker processes (for example, a plurality of GPU cards), each worker process may perform forward propagation computation for a portion of the sequences. Tensor parallelism may also be used, so that each worker process performs forward propagation computation on a portion of vocabulary dimensions.

Since there is no need to generate a next token for the prefilling sequence, the third task may include different operations for the decoding sequences and the prefilling sequences. The third task may include: computing probability distributions of the plurality of next tokens to be generated for the plurality of decoding sequences (i.e., the probability distributions for the plurality of next tokens to be generated for the plurality of unfinished sequences includes a probability distribution for a next token to be generated for each decoding sequence of the plurality of decoding sequences); and performing, for each prefilling sequence, forward propagation computation on one or more prompt token IDs determined for the prefilling sequence in the first task of the current iteration. Forward propagation computation for the prefilling sequence may be performed for generating probability distributions for the prompt token IDs. After obtaining the probability distributions for all prompt token IDs, the inference process for the corresponding sequence may proceed to the decode stage where the token ID of the first token to be generated may be obtained through sampling.

The fourth task 240 is performed by the at least one GPU, and includes sampling from the probability distributions for the plurality of next tokens to obtain token IDs for the plurality of next tokens. The fourth task may alternatively be defined as being configured to sample, on the at least one GPU, from the probability distributions to obtain the token IDs for the plurality of next tokens.

The fourth task may also be referred to as a sampling task (Sampling, T₄). This sampling process involves selecting a next token ID from a vocabulary (i.e., a set of all discrete tokens that the model can understand and generate) based on the probability distributions computed in the third task. In the case that the third task output logits, the fourth task may include applying a normalization function (e.g., softmax) to the logits to obtain normalized probabilities, and sampling from the normalized probabilities to obtain next token IDs. In some embodiments, the sampling process for a next token of an unfinished sequence may use the probability distribution for the next token alone, or may use probability distributions for each of a plurality of latest generated tokens of the same unfinished sequence. The fourth task may be performed with strategies such as greedy search, beam search, top-k sampling, and nucleus sampling, or may use other sampling strategies, which are not limited herein. In some embodiments, the fourth task may be implemented by a parallel sampler. A plurality of sampler instances of the parallel sampler may run on a plurality of GPUs.

Once a token ID of a next token of an unfinished sequence is obtained, the token ID generation process of the current iteration round may be considered complete.

The fifth task 250 is performed by the at least one CPU, and includes updating, based on the token IDs for the plurality of next tokens, completion states of the plurality of unfinished sequences. The fifth task may alternatively be defined as being configured to update, on the at least one CPU, completion states of the plurality of unfinished sequences.

The fifth task 250 may also be referred to as an output processing task (Output Processing, T₅). This task involves adding the token IDs obtained through sampling to the plurality of unfinished sequences (specifically, decoding sequences), mapping these token IDs back to tokens, and converting these tokens into human-readable text strings through detokenization. The detokenized text is incrementally appended to the output string corresponds to the sequence. This task also involves checking a termination condition (for example, whether an end tag <EOS> has been generated) and updates the completion state of the sequence. In some embodiments, the fifth task may be implemented by an output processor thread running on the CPU.

In some embodiments, the inference process for the prefilling sequence may skip sampling (the fourth task) and output processing (the fifth task). For example, a plurality of unfinished sequences determined in the first task of an iteration includes a plurality of decoding sequences and a plurality of prefilling sequences, the second task and the third task of this iteration are performed with regard to both the plurality of decoding sequences and the plurality of prefilling sequences, while the fourth task and the fifth task of this iteration may be performed with regard to the plurality of decoding sequences only.

In some embodiments of the related art, a sequential workflow is usually adopted, meaning that T₁ to T₅ are performed sequentially in each iteration of inference, and different iterations are also performed sequentially. This approach exhibits poor scalability, since among all tasks, only T₃ can achieve parallel acceleration using multiple GPU cards, while other tasks cannot be parallelized by adding more GPUs.

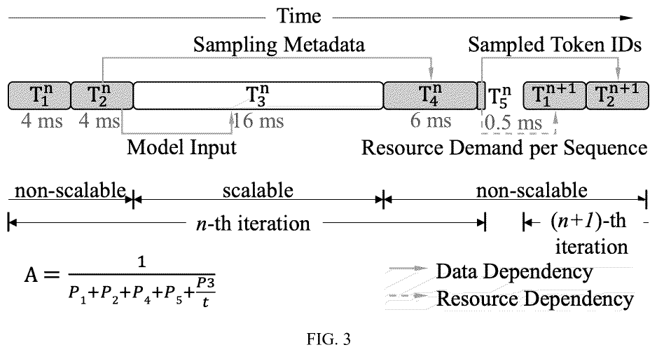

FIG. 3 is a schematic diagram of data and resource dependencies within a single iteration and between adjacent iterations during LLM inference according to an example embodiment of the present disclosure. T₁ⁿ represents performing of a task T₁ in the n^{th} iteration, Pᵢ represents a proportion of average time consumed by T₁ in the entire inference process, t is a parallelism degree, and A is an acceleration ratio. As can be seen from FIG. 3, performing of T₄ requires the sampling metadata determined in T₂, performing of T₃ requires the model input generated in T₂, and there are resource dependencies between T₁ of the next iteration and T₅ of the previous iteration, and performing of T₂ of the next iteration requires T₅ of the previous iteration so that the token ID obtained through sampling is appended into the corresponding sequence. Therefore, in the conventional way, only the processing time for T₃ can be compressed by adding GPUs (scalable), while other tasks cannot achieve this (non-scalable).

In an experiment in which a vLLM framework is adopted, the results show that the GPUs are idle 47.5% of the time, waiting for other tasks to complete. Since T₁, T₂, T₄, and T₅ are non-scalable, the overall inference performance cannot be significantly improved even if more GPUs are added. However, since T₍ₙ₊₁₎ depends on the output of Tₙ, LLM inference solutions in the related art choose to follow this sequential workflow among iterations.

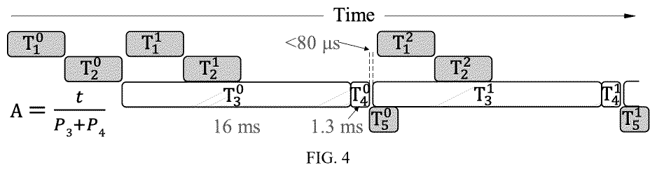

FIG. 4 is a schematic diagram of LLM inference of asynchronously performing iterations according to an example embodiment of the present disclosure. As shown in FIG. 4, the present disclosure proposes a novel LLM inference solution, in which an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration. In this way, CPU-side overheads of T₁, T₂, and T₅ can be hidden within the processing time of T₃ and T₄ on the GPU, resulting in the task performance being mainly determined by T₃ and T₄. This allows the overall performance to scale linearly as the number of GPUs increases.

Therefore, two adjacent iterations of LLM inference are interleaved. While the GPU is still processing forward propagation computation and sampling (i.e., the third task and the fourth task) of the n^{th} iteration, the CPU has already completed model input preparation (i.e., the first task and the second task) for the next (n+1)^{th} iteration in parallel, and then, the GPU's forward propagation computation (the third task) for the (n+1)^{th} iteration can be started after a communication between the CPU and the GPU. In this way, all CPU-side overheads are completely hidden within the GPU's computation window, eliminating the mutual wait between sequential performing of adjacent iterations, thereby reducing inference latency per iteration and improving the overall throughput.

Since a plurality of iterations of LLM inference retain GPU-based forward propagation computation and sampling remained in its critical path, its overall time consumption decreases nearly inversely with the number of newly added GPUs. As a result, system performance scales linearly with the parallelism degree t, enabling LLM inference to achieve acceleration proportional to the number of GPU as the system scales.

In some embodiments, in the present disclosure, the scheduling process is formulated to clearly show resource dependencies between

$${T}_{1}^{n + 1} and {T}_{5}^{n} .$$

For sequence scheduling, an inference framework takes into account a plurality of scheduling budgets, including an upper limit Bₜ on the number of new token IDs that can be generated in each iteration, an upper limit B_{seq} on the number of sequences that the model can process in each iteration, and available GPU memory. In addition, in some embodiments, it is possible to use PagedAttention or other methods to group a key-value cache corresponding to every B_{c} Token IDs in GPU memory into a block, and manage the blocks as “pages” in an operating system. Therefore, the number B_{b} of available blocks is considered as the GPU memory budget. During the scheduling process, a current sequence set may be denoted as [symbol] , where the length of a sequence seq (i.e., the number of token IDs contained) may be denoted as L_{seq}, and accordingly, the number of new token IDs to be generated may be denoted as N_{seq}.

The inference framework needs to be implemented based on a defined scheduling strategy. In an example embodiment, a subset [symbol] ′ is selected from S, and it is ensured that the following conditions are met:

$$max \qquad \vert {𝕊}^{′} \vert$$

$$\begin{matrix}s . t . & {𝕊}^{′} ∈\end{matrix} 𝕊$$

$$\vert {𝕊}^{′} \vert \leq {B}_{seq}$$

$${\sum }_{seg} {N}_{s e q} {I}_{{𝕊}^{′}} ( seq ) \leq {B}_{t}$$

$${\sum }_{s e q} ⌈ \frac{{L}_{s e q} + {N}_{s e q}}{{B}_{c}} ⌉ \text{} {I}_{{𝕊}^{′}} ( seq ) \leq {B}_{b} ,$$

$$where$$

$${I}_{{𝕊}^{′}} ( seq ) ← \{ \begin{matrix}1 , & if seq ∈ {𝕊}^{′} , \\ 0 , & otherwise .\end{matrix}$$

It may be understood that in addition to the method described above, it is also possible to use other scheduling strategies to determine a plurality of unfinished sequences [symbol] ′, for which inference needs to be performed, in the first task.

Asynchronous scheduling is challenging in obtaining a correct set S, because a previous iteration may not have been completed yet. During output processing of the previous iteration, some sequences may terminate early, thus changing their states. Since S directly affects the selection of [symbol] ′ by scheduling, incorrect selection of [symbol] ′ may violate a resource constraint defined in the inequality above. In addition, inaccurate estimation of L_{seq} and N_{seq} in asynchronous scheduling may also lead to violations of these resource dependencies.

For this reason, an optimistic prediction strategy is used in the present disclosure to break resource dependencies between adjacent tasks. In short, with this strategy, memory is allocated on an assumption that “a request never encounters a stop condition”, and L_{seq} and N_{seq} are calculated based on this assumption. This method ensures that scheduling of a next iteration can be initiated before the completion of a current iteration. Under this assumption, a recurrence relation can be easily derived before the sequence seq is completed:

$${L}_{seq}^{n + 1} = {L}_{seq}^{n} \to {N}_{seq}^{n} ,$$

where an initial length

$${L}_{s e q}^{0} = 0 ,$$

and the value of

$${N}_{s e q}^{n}$$

may be inferred depending on the stage (pre-fill or decode) of a sequence, which stage is determined by the current length

$${L}_{s e q}^{n}$$

(for example, comparing to the number of prompt token IDs). The next challenge is how to accurately predict a completion state of a sequence in asynchronous scheduling to ensure correct identification of the sequence set s.

The present disclosure proposes a sequence management mechanism optimized for asynchronous scheduling. In the task

$${T}_{1}^{n + 1}$$

of the (n+1)^{th} iteration, a sequence seq involved in the n^{th} iteration may have two undetermined lengths:

$${L}_{s e q}^{n} before {T}_{5}^{n} , and {L}_{s e q}^{n} + {N}_{s e q}^{n} after {T}_{5}^{n} .$$

This dual-state condition induces potential ambiguity for the scheduler. If

$${T}_{1}^{n + 1} and {T}_{5}^{n}$$

were forced to execute sequentially, this ambiguity would be avoided, but the advantage of asynchronous execution would diminish. To solve this problem, the present disclosure introduces iteration-dependent sequence management, whereby the problem of sequence state inconsistency is eliminated by allocating a dummy state to each token ID in each sequence.

According to some embodiments, the first task may further include: determining, for each unfinished sequence of the plurality of unfinished sequences, a sequence state. This process may be implemented by the scheduler. The sequence state may include the following three items:
an expected length (EL) of the unfinished sequence at the end of the current iteration;
a current length (CL) of the unfinished sequence at the start of the current iteration; and
a number of a next/new token (NNT) to be generated during a current iteration for a decoding sequence or a number of prompt token IDs to be processed in a current iteration for a prefilling sequence.

The current length of the unfinished sequences at the start of a current iteration may be determined based on the expected length of the unfinished sequence at the end of a most recent prior iteration in which inference was performed for the unfinished sequence. Notably, this most recent prior iteration for a target sequence may not be the previous iteration (i.e., immediately preceding iteration) of the current iteration. Instead, it refers to the latest iteration whose first task determines the target sequence as an unfinished sequence, and in which LLM inference was performed on it. Moreover, no subsequent iteration between that prior iteration and the current iteration performs LLM inference on the target sequence.

In an example, the current iteration is a (n+1)^{th} iteration, and a most recent prior iteration is exactly the n^{th} iteration. During the (n+1)^{th} iteration for a sequence, although the n^{th} iteration has not yet ended, a first task of the n^{th} iteration (i.e., in the scheduling stage) was completed and determined, based on the optimistic prediction strategy, that the ELₙ of the sequence should be CLₙ+NNTₙ. Therefore, at the (n+1)^{th} iteration, the CLₙ₊₁ may be determined based on the ELₙ (although sampling operation at the n^{th} iteration may not have been completed yet at this time).

This concise sequence management strategy allows for more efficient pre-scheduling by querying future states (for example, the EL and the NNT) of the sequence in the first task (for example, by the scheduler) based on the number of iterations that the sequence has been scheduled. This method ensures the tracking of consistent states for all sequences during asynchronous execution of

$${T}_{1}^{n + 1} .$$

In addition, the sequence state may also be used to determine position indexes of next tokens to be generated for the plurality of decoding sequences. The position index may be used on the GPU to help the GPU locate the next token to be generated, so as to calculate a probability distribution at a correct position.

In an LLM inference process, keys (K) and values (V) of tokens for which inference has been performed are fixed and will be used in subsequent inference. Therefore, these key-values (KVs) may be cached into the GPU memory to speed up the inference process. Based on this, the present disclosure proposes a KV cache management mechanism for LLM inference, for efficiently managing GPU memory in a multi-sequence parallel inference scenario. As described above, the KVs corresponding to every B_{c} token IDs in the GPU memory may be grouped into a cache block.

According to some embodiments, the first task further comprises determining at least one KV cache block to be allocated for each unfinished sequence of the plurality of unfinished sequences; and obtaining a KV cache block index for the at least one KV cache block. The model input may include the KV cache block index for each unfinished sequence of the plurality of unfinished sequences.

Thereby, in this way, keys and values corresponding to a plurality of tokens of the sequences can be reused across different iterations after only one instance of calculation, and by passing the KV cache block index to the GPU within the model input, the GPU can locate, when performing inference for sequences of the current iteration, a corresponding KV cache block based on the index to obtain cached keys and values for the sequences, thereby enabling fast inference.

It may be understood that in different iterations, cached keys and values in at least one KV cache block of the same sequence may remain unchanged, and a newly calculated new key and value may be written into a partially filled KV cache block in each iteration. In some embodiments, the third task may include: determining, for one unfinished sequence among the plurality of unfinished sequences, at least one corresponding KV cache block based on a KV cache block index for the unfinished sequence; obtaining a cached key and value for the sequence from the at least one corresponding KV cache block; and computing a probability distribution for a next token of the unfinished sequence using the cached key and value for the unfinished sequence, and writing a new key and value generated in the calculation process into a partially filled KV cache block among the at least one corresponding KV cache block.

Since the third task of the n^{th} iteration and the first task of the (n+1)^{th} iteration are performed in parallel, when the first task of the (n+1)^{th} iteration is performed, a new key and value generated in the calculation process of the third task of the n^{th} iteration may not have been written into a corresponding KV cache block. In order to ensure that a new key and value generated in the calculation process of the third task of each iteration can be written to a correct position, the number, index, and free slot information of KV cache blocks of each sequence can be maintained in the first task.

In some embodiments, the first task may include determining, in at least one KV cache block of each of the plurality of unfinished sequences, a KV cache free slot of each of the plurality of unfinished sequences that is used for the current iteration, the model input determined by the second task may include the KV cache free slot of each of the unfinished sequence that is used for the current iteration, and the third task may be configured to write the new key and value generated in the calculation process into the KV cache free slot. In this way, it can be ensured that keys and values generated for the same unfinished sequence in calculation processes in different iterations are written to different positions in a KV cache block.

In some embodiments, the KV cache block index may be implemented as the index (e.g., sequence number or subscript) or position of the corresponding at least one KV cache block in a global block list. The KV cache free slot may be implemented as a KV cache offset. The KV cache offset indicates the position of a token within a corresponding block, or a byte offset in a GPU address space.

The of asynchronous scheduling may involve two key aspects: (A1) determining the number of KV cache blocks required for a sequence in each scheduling iteration, and (A2) predicting whether a next token ID should be further generated for the sequence (i.e., whether further processing is required).

For A1, the core is to compute the number Cₙ of KV cache blocks required for the sequence in the n^{th} iteration.

According to some embodiments, a single KV cache block may accommodate keys and values corresponding to a second predetermined number of tokens. Determining at least one KV cache block to be allocated for each unfinished sequence of the plurality of unfinished sequences may include: determining a number Cₙ of KV cache blocks to be allocated for each unfinished sequence of the plurality of unfinished sequence based on a sequence length of the unfinished sequence and the second predetermined number.

In an example embodiment, Cₙ may be computed in the following interactive manner:

$${C}_{n} ← ⌊ \frac{{L}_{n} + {B}_{c} − 1}{{B}_{c}} ⌋ ,$$

$$where {L}_{n} ← \{ \begin{matrix}{L}_{n + 1} + 1 , & {L}_{n − 1} \geq {N}_{p} , \\ {L}_{n − 1} + {N}_{c} , & {L}_{n − 1} < {N}_{p} .\end{matrix}$$

Here, L represents the length of the sequence, L₀=0, Nₚ represents the number of prompt token IDs in a sequence, and N_{c} represents a block size for token IDs processed in the prefill stage. During the prefill stage (for Lₙ₋₁<Nₚ), Lₙ may be updated based on a predetermined N_{c} to improve the efficiency of a prefill process. In contrast, during the decode stage, since only one token ID is generated per iteration, it is sufficient to increase the current length by one.

According to some embodiments, the number of a next token to be generated during a current iteration for a decoding sequence is 1, and the number of prompt token IDs to be processed in a current iteration for a prefilling sequence does not exceed a first predetermined number N_{c}, the first predetermined number N_{c} being not less than 2.

In some embodiments, Nₚ may be an integer multiple of N_{c}, allowing the same number of prompt token IDs to be processed in each iteration of the prefill stage. N_{c} may also be set such that a remainder of Nₚ÷N_{c} is as close to N_{c} as possible, allowing for fuller utilization of computing resources in the last iteration of the prefill stage.

It may be understood that in addition to the approaches described above, it is also possible to use other approaches to determine the number Cₙ of KV cache blocks required for each unfinished sequence in the n^{th} iteration.

In some embodiments, after the number Cₙ of KV cache blocks required for each unfinished sequence in the n^{th} iteration is obtained, the number Cₙ may be compared with the number of KV cache blocks that have been allocated for each unfinished sequence. If the number Cₙ of KV cache blocks required for a sequence in the n^{th} iteration is greater than the number of KV cache blocks that have been allocated for the sequence, at least one additional KV cache block needs to be allocated for the sequence, and the number, index, and free slot information of KV cache blocks of the sequence need to be updated accordingly. If the number Cₙ and the number of KV cache blocks are the same, there is no need to allocate a new KV cache block, but the free slot information of the KV cache blocks of the sequence still needs to be updated.

In some embodiments, after a sequence is finished, all KV cache blocks allocated to the sequence may be reclaimed.

When there are many sequences of different lengths and different progresses for inference at the same time, using a conventional contiguous memory method to manage KV caches may result in severe memory fragmentation and waste, and frequent allocation and reclaim of memory may also induce additional overheads. The present disclosure proposes a flexible KV cache management mechanism that can better support the multiple-sequence parallel inference scenario, effectively alleviating the problem of GPU fragmentation and waste, thereby improving the GPU utilization and overall inference efficiency.

For A2, the optimistic prediction strategy can be used, in which it is assumed that inference needs to be continued for each sequence in each iteration. In practice, this strategy is highly effective because for a sequence with N tokens generated, the number of successful predictions is N−1 and only the last prediction fails, resulting in a total of N+1 token IDs being generated.

In addition, by using single-iteration asynchronous scheduling, scheduling the (n+1)^{th} iteration during the n^{th} iteration brings at least two benefits. First, referring to FIG. 4, the method allows for complete overlapping of CPU computation (the first task and the second task) of the (n+1)^{th} iteration and GPU computation (the third task and the fourth task, mainly involving the decoding forward propagation process) of the n^{th} iteration to hide CPU computational overheads, while adding only a minor time overhead between the fourth task of the n^{th} iteration and a third task of the (n+1)^{th} iteration. In some embodiments, the added minor time overhead may include the GPU (for example, a parallel sampler running thereon) writing sampling outputs of the n^{th} iteration to a queue, and the GPU taking the model input of the (n+1)^{th} iteration from the queue (in preparation for the third task of the (n+1)^{th} iteration). This process usually takes no more than 80 microseconds.

Moreover, for online services, when a new request arrives, scheduling of a prefill task needs to be recalculated to ensure consistent latency for generating the first token. Therefore, in asynchronous scheduling, the greater the number of iterations that are performed in advance, the higher the likelihood of invalid scheduling is. Single-iteration asynchronous scheduling achieves an effective balance between computational overhead and performance improvement.

Therefore, by decoupling the scheduling process (i.e., the first task) from a sequentially executed workflow as an asynchronous operation, the input processing (i.e., the second task) can be asynchronously executed in advance, thereby greatly shortening the total duration of LLM inference of a plurality of iterations.

In some embodiments, when generating the (n+1)^{th} token ID in the (n+1)^{th} iteration, the model requires the n^{th} token ID in a sequence as part of the model input. Without this n^{th} token ID, the model will generate an incorrect token ID, leading to an inference error.

In order to decouple the input processing and the output processing from the sequentially performed workflow and eliminate the dependency that causes the input processing of the next iteration to wait for output processing of the previous iteration, the present disclosure introduces an early feedback backfill mechanism. This mechanism establishes a fast channel from a sampling task (the fourth task) of an iteration to an output processing task (the fifth task) of the same iteration and an input processing task (the first task) of a next iteration. The channel may be, for example, established between the sampler running on the GPU and the input processor and output processor running on the CPU. During sampling, each newly generated token ID is immediately forwarded to the CPU. This ensures that the model input remains consistent with model input in the sequentially performed workflow and avoids a potential inference error.

Input processing of the (n+1)^{th} iteration depends on scheduling outputs of the (n+1)^{th} iteration and sampling outputs of the n^{th} iteration. These dependencies prevent existing inference framework in the art from performing input processing asynchronously. In the solution proposed in the present disclosure, input processing (the second task) of the (n+1)^{th} iteration can directly access the scheduling outputs (the processing result of the first task) of the (n+1)^{th} iteration described in the asynchronous scheduling, thereby reducing the data dependencies to the extent of depending only on the sampling outputs of the n^{th} iteration (an intermediate result of the fourth task of a previous iteration).

According to some embodiments, determining the plurality of unfinished sequences and latest generated token IDs for the plurality of unfinished sequences of the first task may include: in response to determining that the plurality of unfinished sequences include a target sequence that is determined as an unfinished sequence in a first task of a previous iteration, assigning a placeholder token ID as a latest generated token ID of the target sequence. Generating the model input of the second task may include: forming a first tensor, the first tensor including the latest generated token IDs of the plurality of unfinished sequences; and backfilling, after a target token ID for the target sequence was obtained through sampling in a fourth task of the previous iteration, the place holder token ID in the first tensor with the target token ID, where the model input includes a backfilled first tensor.

Although a token ID at an end position of a target sequence of the (n+1)^{th} iteration depends on a sampling result of a fourth task of the n^{th} iteration (given that the n^{th} iteration performed LLM inference on the target sequence), the shape of the first tensor (which includes last-generated token IDs for the plurality of unfinished sequences, specifically for the plurality of decoding sequences), formed at the second task of the (n+1)^{th} iteration, is determined only by the scheduling outputs at the first task of the (n+1)^{th} iteration. This allows the input processor to form the first tensor immediately after receiving the processing result of the first task, without waiting for the completion of the sampling process of the previous iteration. For a target sequence for which inference is also being performed in the previous iteration, since the “latest generated token ID” for the target sequence has not actually been generated yet at this time, a placeholder token ID is temporarily used as the latest generated token ID of this target sequence. After the fourth task of the previous iteration completes sampling, a sampling result indicating the generated token ID of the target sequence may be immediately backfilled into the corresponding placeholder token ID in the first tensor to ensure that the model input including the first tensor can provide accurate token IDs for the target sequence to the GPU.

According to some embodiments, generating the model input may further include: forming a second tensor, the second tensor including position indexes of the plurality of next tokens in respective sequences, and the model input including the second tensor; and sending the second tensor to the at least one GPU prior to the backfilling.

In addition to the first tensor including a last-generated token ID for each unfinished sequence (specifically, decoding sequence), a second tensor may be formed in the second task. The second tensor includes position indexes of the plurality of next tokens to be generated for the plurality of unfinished sequences in the respective sequences. These position indexes may be determined based on the sequence states of the plurality of unfinished sequences determined in the first task, as mentioned above, and may be used, by the GPU, to locate positions for tokens to be generated. This allows the probability distributions to be computed at correct positions. Since these position indexes do not depend on the sampling process of the previous iteration, it is possible to determine the second tensor immediately after the start of the second task, and send the second tensor to the GPU prior to backfilling, without waiting for the sampling process to complete.

In some embodiments, after the placeholder token IDs in the first tensor have been backfilled, the backfilled first tensor may be sent to the GPU.

In some cases, the plurality of unfinished sequences scheduled in the current iteration may not include any sequence scheduled in the previous iteration. In other words, a previous token generation process has been completed for each of the plurality of unfinished sequences scheduled in the current iteration. Therefore, the latest generated token IDs for the plurality of unfinished sequences may be obtained in the first task, and the placeholder token ID is no longer necessary.

According to some embodiments, generating the model input may further include: in response to determining that the plurality of unfinished sequences do not include any sequence that is determined as an unfinished sequence in the first task of the previous iteration, sending the first tensor to the at least one GPU after the first tensor is formed without backfilling.

In some case, the first tensor may be sent to the GPU immediately after the first tensor is formed in an input processing stage without backfill.

In some embodiments, the second task may further include calculating metadata. The model input may further include metadata. The metadata may include a batch size required for an inference process of the third task, a current length of each sequence, an index and a free slot of a KV cache block of each sequence, etc., and may also include sampling control parameter required for the fourth task in a sampling stage, such as a sampling strategy. The calculation of the metadata does not require the latest generated token ID, and therefore, it may also be started immediately after the first task is completed.

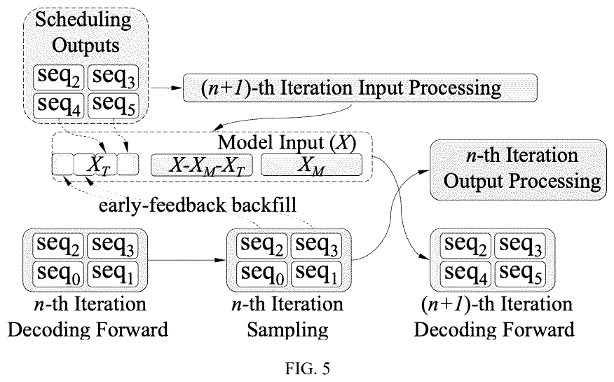

FIG. 5 is a schematic diagram of input processing according to an example embodiment of the present disclosure. Referring to FIG. 5, after decoding forward propagation of the n^{th} iteration, a sampling process of the n^{th} iteration may be performed, and then output processing of the n^{th} iteration may be performed. In addition, after the scheduling outputs of the (n+1)^{th} iteration (the upper-left box) are obtained, the input processing of the (n+1)^{th} iteration may be performed to obtain a model input X. X_{M} is the metadata; X_{T} is the first tensor, that is, the latest generated token IDs for the plurality of unfinished sequences; and X−X_{M}−X_{T} is another tensor, such as the second tensor, that is, position indexes of a plurality of next tokens to be generated for the plurality of unfinished sequences in the current iteration. It can be seen that for seq2 and seq3 scheduled in the n^{th} iteration, a sampling result may be backfilled into the first tensor X_{T} using the early feedback backfill mechanism; and for seq4 and seq5 that are not scheduled in the n^{th} iteration, since latest generated token IDs for these sequences have been obtained through sampling in an earlier iteration, the latest generated token IDs for these sequences may be obtained directly from a scheduling result. After the model input is obtained, the decoding forward propagation of the (n+1)^{th} iteration may be performed.

According to some embodiments, the second task may further include writing the model input into a first queue, and the third task may further include retrieving the model input from the first queue, the first queue being used for communication from the at least one CPU to the at least one GPU.

By using the first queue, an efficient connection from the second task to the third task in the same iteration can be achieved.

According to some embodiments, the fourth task may further include writing a token ID of a next token of the second sequence into a second queue, and the fifth task may further include retrieving the token ID of the next token of the second sequence from the second queue, the second queue being used for communication from the at least one GPU to the at least one CPU.

By using the second queue, an efficient connection from the fourth task to the fifth task in the same iteration can be achieved.

In some embodiments, the early feedback backfill mechanism from the fourth task of the n^{th} iteration (the sampler on the GPU) to the second task of the (n+1)^{th} iteration (the input processor on the CPU) may be implemented through a queue, or may be implemented in other manners. This is not limited here.

According to some embodiments, a first task of the (n+2)^{th} iteration is performed after the fifth task of the n^{th} iteration. During the first task of the (n+2)^{th} iteration, the CPU may determine all unfinished sequences by checking the completion state of all sequences, and then select a subset of them to be scheduled in the (n+2)^{th} iteration.

Before the fifth task of the n^{th} iteration is completed, it remains unknown whether inference for a sequence scheduled in this iteration is finished, as its completion state of this sequence has not yet been updated. If the first task of the (n+2)^{th} iteration starts prematurely, it may lead to a situation where a sequence whose inference is actually complete after the n^{th} iteration is none the less scheduled in the (n+2)^{th} iteration. As shown in FIG. 4, the total duration of the fifth task of the n^{th} iteration and the first task and a second task of the (n+2)^{th} iteration is still shorter than the duration of the third task of the (n+1)^{th} iteration. Therefore, the performing of the first task of the (n+2)^{th} iteration may be delayed until the fifth task of the n^{th} iteration begins.

In some embodiments of the related art, the sampling process may be formulated as:

$${Pr}_{1}^{v} , {Pr}_{2}^{v} = DecodingForward ( X )$$

$$Pr = g ( {Pr}_{1}^{v} , {Pr}_{2}^{v} )$$

$$Y = Sample ( Pr ) ,$$

where X is the model output, Pr is a probability for the output of a task T₃, g( ) represents a gather( ) operation, and Y represents the sampling result. A probability matrix is composed of s×v elements, indicating probabilities of v tokens in a vocabulary for s requests. [symbol] represents partition of the matrix along a vocabulary dimension.

In an example framework, sampling maintains single-threaded execution for two main reasons.

First, parallel sampling is incompatible with model parallelism. Sampling is performed along the vocabulary dimension, which vocabulary dimension is already split across tensor parallel groups. Furthermore, sampling depends on the output of the last layer of the model, which means that sampling cannot be performed directly until a final stage of pipeline parallelism. Therefore, distributing sampling to other worker nodes in model parallelism requires expensive collective communication, which results in millisecond-level latency per iteration.

Second, sampling requires additional metadata as an input, which introduces significant communication overheads. Specifically, each worker node may be configured to receive settings (such as a temperature and a penalty term) and a sampling state for each sequence. Directly serializing the data into a binary format using a module like Pickle may incur significant overheads. For example, for a batch size of 256, an overhead of more than ten milliseconds per iteration may be incurred. Therefore, broadcasting the data between worker nodes will severely affect performance (for example, vLLM has a throughput loss of 37%).

It has been observed that, in non-parallel sampling, operations for s×v logits are independent in a sequence dimension. This independence enables a sampling workload to be split among the plurality of GPUs (also referred to as the plurality of worker processes of the GPU in the present disclosure), thereby improving scalability.

According to some embodiments, at least one GPU corresponds to a plurality of worker processes, and after computing the probability distributions, each worker process of the plurality of worker processes holds a probability distribution over a partial vocabulary for all or a portion of the plurality of decoding sequences. The sampling from the probability distributions for the plurality of next tokens may include: performing an all-to-all data exchange operation among the plurality of worker processes, such that each worker process holds a probability distribution over a full vocabulary for one or more decoding sequences associated with the worker process; sampling, on each worker process, from a probability distribution over a full vocabulary for each decoding sequence associated with the worker process, to obtain a token ID for a next token for the decoding sequence; and gathering sampling results of the plurality of worker processes to obtain token IDs for the plurality of next tokens.

A sequential parallel sampling process may be expressed as follows:

$$[ {Pr}_{1}^{v} , {Pr}_{2}^{v} ] = DecodingForward ( X )$$

$$[ {Pr}_{1}^{s} , {Pr}_{2}^{s} ] = \hat{g} ( {Pr}_{1}^{v} , {Pr}_{2}^{v} )$$

$${Y}_{1}^{s} = Sample ( {Pr}_{1}^{v} ) and {Y}_{2}^{s} = Sample ( {Pr}_{2}^{s} )$$

$$Y = g ( [ {Y}_{1}^{s} , {Y}_{2}^{s} ] ) ,$$

where g and ĝ respectively represent a gather operation and an all-to-all operation. The sampling workflow may include four steps:
1. A driver node uses a scatter operation to distribute sampling metadata for different sequences to worker nodes (i.e., worker processes).
2. Each worker node performs an all-to-all data exchange operation after decoding forward computation to exchange probabilities of the vocabulary, and the data is split by sequence dimension.
3. Core sampling computation remains unchanged, but each worker node processes a smaller subset of requests independently.
4. The driver node aggregates token IDs sampled by all worker nodes into an array, and sends same through the early feedback backfill mechanism.

The procedure described above greatly improves processing efficiency and reduces performance bottlenecks by parallelizing the sampling process and processing each request in a distributed manner.

According to some embodiments, a more efficient logit exchange method is used in the present disclosure. In conventional settings, the driver node gathers probabilities over vocabulary dimensions from all worker nodes for sampling. However, once the sampling workload is distributed across all the worker nodes, each worker node must access these probabilities. To optimize this process, in the present disclosure, the conventional gather operation is replaced with the all-to-all operation, which gathers the probabilities over the vocabulary dimension and also splits them according to the batch size. The method eliminates the need for the worker nodes to separately split the output of an allgather operation. Therefore, the amount of data transmitted by each worker node is the same as that in a single gather operation, ensuring that the parallel sampling does not introduce additional communication overheads in this stage.

The driver node may gather results only after the sampling is completed. Each result includes a single token ID and a sequence ID for each sequence. Therefore, even for a large batch of requests, the communication overhead remains minimal, effectively reducing latency. In an example embodiment, for 256 requests, only about 200 microseconds of delay is observed.

According to some embodiments, the second task may include determining sampling metadata for each decoding sequence. The sampling metadata for the each decoding sequence may be send to the at least one GPU during performing of the third task. The sampling from the probability distributions for the plurality of next tokens may include sampling, for each decoding sequence, based on sampling metadata for the decoding sequence and from a probability distribution of a next token to be generated for the decoding sequence, to obtain a token ID for the next token.

In some embodiments, forward propagation computation before sampling is a GPU-bound operation, and a large amount of sampling metadata is required after the forward propagation computation is completed. In view of this, the present disclosure proposes an approach in which the scatter operation is delayed until after the forward propagation starts, thereby effectively hiding communication overheads within the inevitable GPU computing time. The ratio of a sampling metadata scatter time to a forward propagation time is defined as Rₛ. In most cases, even on an H100 GPU, Rₛ is below 20% because metadata has a relatively small size (about 1.5 KB per request for a sequence having a length of 1000). This complete overlapping effectively eliminates communication overheads associated with scatter.

According to some embodiments, the model input may further include an original index for each decoding sequence of the plurality of decoding sequences, and an index for each decoding sequence within a corresponding worker processes may be determined by applying a modulo operation to the original index of the decoding sequences with respect to the number of the plurality of worker processes.

In some embodiments a third tensor (also referred to as an index tensor) may be formed in the second task, and the third tensor includes the original index of each decoding sequence of the plurality of decoding sequences. The third tensor may be sent to the GPU before backfilling, if any.

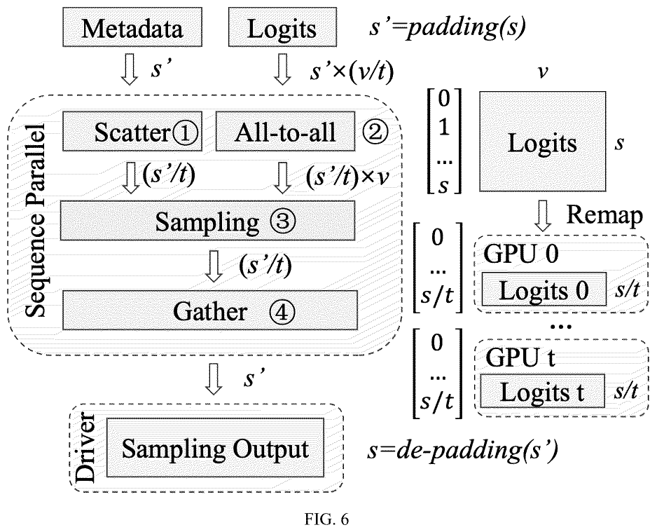

During sampling, the index tensor is used to select a specific row in a logits matrix for matrix multiplication and related computations (for example, [0, 1, . . . , s] in FIG. 6). When sampling is distributed among t worker nodes, each worker node only holds s/t rows of logits, which makes the original index invalid. To solve this problem, the present disclosure introduces a remapping process: (1) realigning an index with its corresponding target, and (2) applying modulo operations to an original index based on the number of worker nodes, to ensure accurate mapping from an index ([0, 1, . . . s/t]) of each worker node to a logits target row.

According to some embodiments, the fourth task may include: padding the plurality of unfinished sequences with one or more placeholder sequences prior to performing the all-to-all data exchange operation, so that a number of sequences after padding is divisible by a number of the plurality of worker processes; and discarding sampling results for the one or more placeholder sequences after gathering the sampling results of the plurality of worker processes.

In some embodiments of the related art, an example collective communication framework generally requires that the number of data items be divisible by the number of worker nodes. When a batch size is not divisible by the number of worker nodes, problems arise. In order to enable sequence-parallel sampling in all cases, the present disclosure proposes a batch padding technique such that s′ mod t=0. The technique is implemented by adding synthetic metadata to a placeholder (dummy) request and padding a logit tensor with an extra row. Then, the driver worker node discards sampling results of the padding request before performing an early feedback backfill operation. Although this introduces some additional communication padding overheads (less than 10 KB of metadata padding), the advantage of parallel sampling far outweighs these costs, ultimately speeding up the inference process.

FIG. 6 is a schematic diagram of a parallel sampling process according to an example embodiment of the present disclosure. First, a padding operation may be performed for a plurality of unfinished sequences s to obtain a plurality of padded sequences s′. For a GPU cluster with a parallelism degree of t, each worker process includes probability distributions of all sequences s′ over v/t vocabulary dimensions, where v represents the full vocabulary dimension. Metadata and logits corresponding to s′ may undergo a scatter operation \textcircled{1} and an all-to-all data exchange operation \textcircled{2}. After the scatter operation \textcircled{1}, each worker process has metadata for s′/t sequences that the process needs to process, and after the all-to-all data exchange operation \textcircled{2}, each worker process has probability distributions of the s′/t sequences that the process needs to process over the full vocabulary dimension. Furthermore, sampling \textcircled{3} may be performed in each worker process, and each worker process obtains sampling results for s′/t sequences, and the sampling results from different worker processes are gathered \textcircled{4} to obtain sampling results for the s′ sequences. The aforementioned process implements a sequence-parallel sampling process. Then, the driver node may be used to complete a de-padding operation and discard the sampling result for the padding sequence, to obtain sampling results for the plurality of original sequences s. In addition, remapping may be performed on the plurality of unfinished sequences s by different worker processes (for example, t GPUs ranging from GPU 0 to GPU t).

According to some embodiments, an identical set of random numbers may be pre-generated on each worker process of the plurality of worker processes, and each worker process may use a subset of the identical set of random numbers during the third task and/or the fourth task.

Random numbers are crucial in operations such as multinomial distributions, where a fixed random seed is intended to generate a deterministic result. However, different worker nodes do not share the states of random number generators. Therefore, generating k/t random numbers independently on t worker nodes may result in different results than generating all k random numbers on a single worker node. To address this problem and maintain full compatibility with the original method, all k random numbers may be pre-generated on all t GPUs such that each worker node only uses a subset of the random numbers. This method realizes lower communication overheads (saving about 1 millisecond of remote GPU read time) at the cost of extra GPU memory (about 128 KB per request).

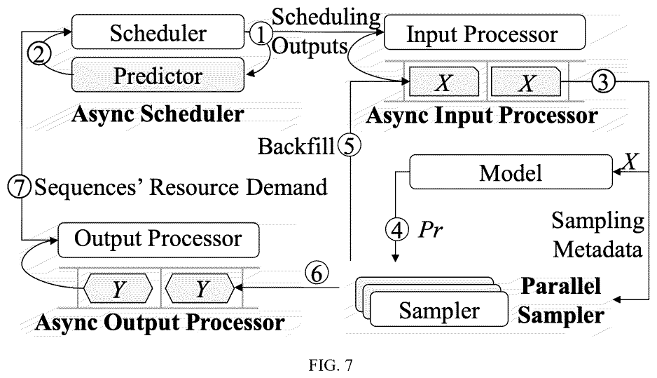

FIG. 7 is a schematic diagram of LLM inference according to an example embodiment of the present disclosure. The n^{th} decoding forward propagation starts on the GPU, while scheduling of the (n+1)^{th} iteration is initiated on the CPU.

On the CPU side, a scheduler evaluates the state of a current sequence and generates scheduling outputs of the (n+1)^{th} iteration based on a serving strategy (such as FCFS). The outputs are forwarded to a predictor and an input processor (\textcircled{1}). The predictor predicts the number of KV cache blocks required for each scheduling sequence in a next iteration and actively updates the state thereof, so as to make preparation for scheduling of the next iteration (\textcircled{2}). Meanwhile, the input processor converts the scheduling outputs into a model input, generates corresponding sampling metadata, and caches same in a queue.

On the GPU side, the model input and the sampling metadata in the n^{th} iteration may be obtained from the queue of the input processor, and then transmitted to the model and the parallel sampler (\textcircled{3}) simultaneously. After decoding forward propagation is completed, the parallel sampler distributes probability distribution logits (Pr, representing the probability distribution) from the model to sampler instances (\textcircled{4}). Each instance performs parallel sampling independently using the sampling metadata. Each sample instance may correspond to a worker process or to a GPU card.

Once a sampled token ID is determined, the parallel sampler immediately sends it to an output processor to backfill the model input for the (n+1)^{th} iteration (\textcircled{5}). This operation is crucial in an asynchronous scheduling scenario, because in this case, some sequences may appear in both the n^{th} and (n+1)^{th} iterations, but their latest generated token IDs have not yet been determined at the time of scheduling (i.e., the first task of the (n+1)^{th} iteration). In this case, the scheduler inserts a placeholder token ID at a corresponding position, and a backfill operation can ensure correct inference. Once sampling is completed, the parallel sampler passes outputs to the output processor Meanwhile, the output processor continuously extracts sampling results from the queue, updates the state of unfinished sequences, and removes completed sequences (\textcircled{7}).

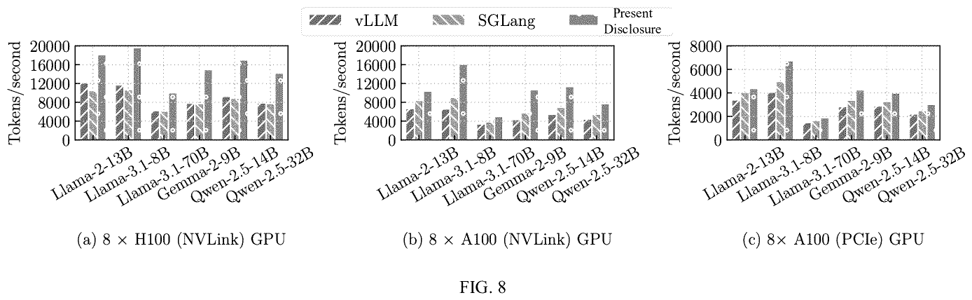

In some embodiments, the proposed solution in the present disclosure was evaluated on three test platforms, each equipped with eight GPUs of a specific type: NVIDIA H100 (NVLink), NVIDIA A100 (NVLink), and NVIDIA A100 (PCIe). In the test, average throughput is measured for different inference frameworks in FIG. 8.

The evaluation indicates that: (1) the proposed solution achieves improvements on different models; and (2) the proposed solution maintains a consistent improvement ratio for different maximum sequence output lengths.

The same experiment was conducted on test platforms equipped with H100 (NVLink), A100 (NVLink) and A100 (PCIe), as shown in part (a)-part (c) of FIG. 8. On the three test platforms, the solution proposed in the present disclosure provides a better performance than vLLM, proving that the design of the proposed solution is GPU-independent and can achieve performance improvements on a wide range of GPUs.

Further, experimental results show that the solution proposed in the present disclosure has a better acceleration effect on A100 (NVLink) than on A100 (PCIe). The reason is that forward propagation requires data to be exchanged between GPUs, and NVLink has lower communication overheads than PCIe.

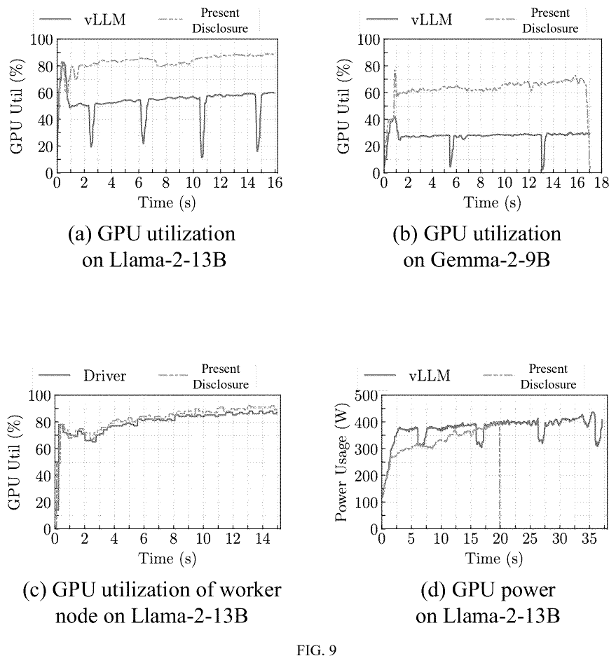

In FIG. 9, (a), (b), and (c) respectively show the average GPU utilization for the solution proposed in the present disclosure compared with vLLM. The results show that: (1) through asynchronous execution, the solution proposed in the present disclosure improves the average GPU utilization on Llama-2-13B and Gemma-2-9B by reducing the GPU idle time in T₁, T₂, and T₅; and (2) the GPU utilization is evenly distributed among all worker threads (see part (c) of FIG. 9) because the parallel sampler distributes the sampling task-which is usually concentrated in threads of the driver node in other frameworks-evenly to all worker threads.

The solution proposed in the present disclosure achieves energy-efficiency optimized inference, while improving the GPU utilization. In FIG. 9, part (d) shows the average GPU power consumption using different frameworks in an inference process. The results show that the solution proposed in the present disclosure reduces the average GPU power consumption and the inference time, thereby resulting in overall energy savings.

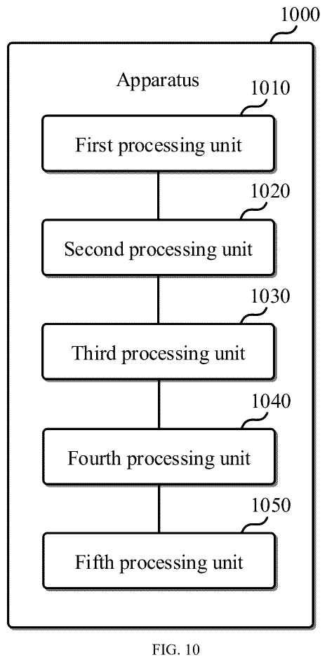

According to another aspect of the present disclosure, there is proposed an apparatus for large language model inference, configured to use at least one CPU and at least one GPU collaboratively, to perform a plurality of iterations of LLM inference, where each iteration of the plurality of iterations includes a first task, a second task, a third task, a fourth task, and a fifth task that are performed in sequence. As shown in FIG. 10, the apparatus 1000 includes: a first processing unit 1010 configured to perform the first task on the at least one CPU, the first task including determining a plurality of unfinished sequences and latest generated token IDs of the plurality of unfinished sequences; a second processing unit 1020 configured to perform the second task on the at least one CPU, the second task including generating a model input based on the latest generated token IDs for the plurality of unfinished sequences; a third processing unit 1030 configured to perform the third task on the at least one GPU, the third task including computing, based on the model input, probability distributions for a plurality of next tokens to be generated for the plurality of unfinished sequences; a fourth processing unit 1040 configured to perform the fourth task on the at least one GPU, the fourth task including sampling from the probability distributions for the plurality of next tokens to obtain token IDs for the plurality of next tokens; and a fifth processing unit 1050 configured to perform the fifth task on the at least one CPU, the fifth task including updating, based on the token IDs for the plurality of next tokens, completion states of the plurality of unfinished sequences. An (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.

It should be understood that the modules of the apparatus 1000 shown in FIG. 10 may correspond to the tasks in the method 200 described with reference to FIG. 2. Therefore, the operation, features, and advantages described above for the method 200 are equally applicable to the apparatus 1000 and the modules included therein. For the sake of brevity, some operations, features, and advantages are not described herein again.

According to an aspect of the present disclosure, there is provided a computer device, including a memory, a processor, and a computer program stored on the memory. The processor is configured to execute the computer program to implement the steps of any of the method embodiments described above.

According to an aspect of the present disclosure, there is provided a non-transitory computer-readable storage medium having a computer program stored thereon, where when the computer program is executed by a processor, the steps of any of the method embodiments described above are implemented.

According to an aspect of the present disclosure, there is provided a computer program product, including a computer program, where when the computer program is executed by a processor, the steps of any of the method embodiments described above are implemented.

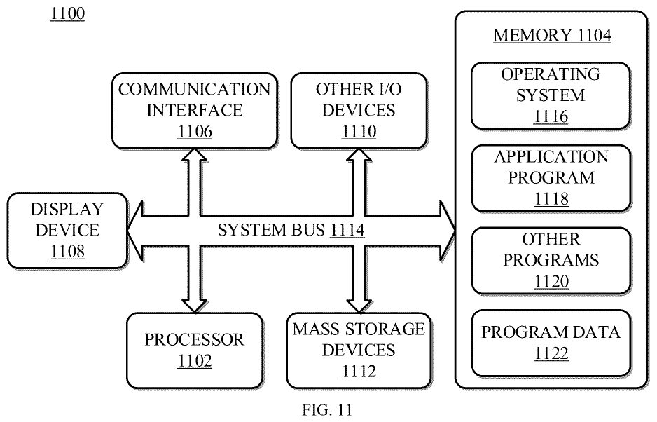

Illustrative examples of such a computer device, a non-transitory computer-readable storage medium, and a computer program product will be described below in conjunction with FIG. 11.

FIG. 11 shows an example configuration of a computer device 1100 that may be used to implement the method described herein. For example, the server 120 and/or the client device 110 shown in FIG. 1 may include an architecture similar to the computer device 1100. The apparatus 1000 may also be implemented, in whole or at least in part, by the computer device 1100 or a similar device or system.

The computer device 1100 may be various different types of devices. Examples of the computer device 1100 include, but are not limited to: a desktop computer, a server computer, a laptop computer or a netbook computer, a mobile device (e.g. a tablet computer, cellular or other wireless phones (e.g. smart phones), a notebook computer, a mobile station), a wearable device (e.g. glasses, a watch), an entertainment device (e.g. an entertainment appliance, a set-top box communicatively coupled to a display device, a game console), a television or other display devices, a car computer, etc.

The computer device 1100 may include at least one processor 1102, a memory 1104, communication interface(s) 1106, a display device 1108, other input/output (I/O) devices 1110, and one or more mass storage devices 1112 that can communicate with each other, such as through a system bus 1114 or other appropriate connections.

The processor 1102 may be a single processing unit or a plurality of processing units, and all the processing units may include a single computing unit or a plurality of computing units or a plurality of cores. The processor 1102 may be implemented as one or more microprocessors, microcomputers, micro-controllers, digital signal processors, central processing units, state machines, logic circuits, and/or any devices that manipulate signals based on operation instructions. In addition to other capabilities, the processor 1102 may be configured to acquire and execute computer-readable instructions stored in the memory 1104, the mass storage device 1112, or other computer-readable media, such as program code of an operating system 1116, program code of an application program 1118, and program code of other programs 1120.

The memory 1104 and the mass storage device 1112 are examples of the computer-readable storage medium used for storing instructions, and the instructions are executed by the processor 1102 to implement the various functions described above. By way of example, the memory 1104 may generally include both volatile memory and non-volatile memory (e.g. RAM, ROM, etc.). In addition, the mass storage device 1112 may generally include a hard disk drive, a solid state drive, a removable medium, including external and removable drives, a memory card, a flash memory, a floppy disk, an optical disk (e.g. CD, DVD), a storage array, a network attached storage, a storage area network, etc. The memory 1104 and the mass storage device 1112 may be collectively referred to herein as a memory or a computer-readable storage medium, and may be a non-transitory medium capable of storing computer-readable and processor-executable program instructions as computer program code. The computer program code may be executed by the processor 1102 as a specific machine configured to implement the operations and functions described in the examples herein.

A plurality of programs may be stored on the mass storage device 1112. These programs include an operating system 1116, one or more application programs 1118, other programs 1120, and program data 1122, and they may be loaded onto the memory 1104 for execution. Examples of such applications or program modules may include, for example, computer program logic (for example, computer program code or instructions) for implementing the following components/functions: the client application 112 (including a sending module 112a, a receiving module 112b, a pattern generation module 112c, and a display module 112d), a resource transfer application 128 (including a receiving module 128a, a resource transfer module 128b, a sending module 128c, a credit management module 128d, an access control module 128e, a transaction status setting module 128f, and a message generation module 128g), the method 200 and/or the method 300 (including any suitable steps of the methods 200 and 300), and/or other embodiments described herein.

Although shown in FIG. 11 as being stored in the memory 1104 of the computer device 1100, the modules 1116, 1118, 1120, and 1122 or parts thereof may be implemented using any form of computer-readable medium that is accessible by the computer device 1100. As used herein, “computer-readable medium” includes at least two types of computer-readable media, that is, a computer-readable storage medium and a communication medium.

The computer-readable storage medium includes volatile and nonvolatile, removable and non-removable media implemented by any method or technology for storage of information, such as computer-readable instructions, data structures, program modules, or other data. The computer-readable storage medium includes, but is not limited to, RAM, ROM, EEPROM, a flash memory or other memory technologies, CD-ROM, a digital versatile disk (DVD), or other optical storage apparatuses, a magnetic cassette, a tape, a disk storage apparatus or other magnetic storage devices, or any other non-transmission media that can be used to store information for access by a computer device. In contrast, the communication medium may specifically implement computer-readable instructions, data structures, program modules, or other data in a modulated data signal, such as a carrier wave or other transmission mechanisms. The computer-readable storage medium as defined herein does not include the communication medium.

One or more communication interfaces 1106 are configured to exchange data with other devices, such as over a network or a direct connection. Such a communication interface can be one or more of the following: any type of network interface (e.g. a network interface card (NIC)), a wired or wireless (such as IEEE 802.11 wireless LAN (WLAN)) wireless interface, a world interoperability for microwave access (Wi-MAX) interface, an Ethernet interface, a universal serial bus (USB) interface, a cellular network interface, a Bluetooth™ interface, a near field communication (NFC) interface, etc. The communication interface 1106 can facilitate communication within a variety of networks and protocol types, including wired networks (for example, LAN, cables, etc.) and wireless networks (for example, WLAN, cellular, satellite, etc.), the Internet, etc. The communication interface 1106 may also provide communication with an external storage apparatus (not shown) in a storage array, a network attached storage, a storage area network, etc.

In some examples, the display device 1108 such as a monitor may be included for displaying information and images to a user. The other I/O devices 1110 may be devices that receive various inputs from a user and provide various outputs to the user, and may include a touch input device, a gesture input device, a camera, a keyboard, a remote controller, a mouse, a printer, audio input/output devices, etc.

The technologies described herein may be supported by these various configurations of the computer device 1100 and are not limited to the specific examples of the technologies described herein. For example, this functionality may also be implemented all or in part over a “cloud” through use of a distributed system. The cloud includes and/or represents a platform for resources. The platform abstracts underlying functions of hardware (for example, servers) and software resources of the cloud. The resources may include applications and/or data that can be used while computing processing is executed on servers that are remote from the computer device 1100. Resources may further include services provided over the Internet and/or over a subscriber network, such as a cellular or Wi-Fi network. The platform may abstract resources and functions to connect the computer device 1100 to other computer devices. Accordingly, implementation of the functions described herein may be distributed throughout the cloud. For example, the functions may be implemented in part on the computer device 1100 and in part through a platform that abstracts the functions of the cloud.

Although the present disclosure has been illustrated and described in detail in the drawings and the above description, such illustration and description should be considered illustrative and schematic, rather than limiting; and the present disclosure is not limited to the disclosed embodiments. By studying the accompanying drawings, the present disclosure, and the appended claims, those skilled in the art can understand and implement modifications to the disclosed embodiments when practicing the claimed subject matter. In the claims, the word “comprising” does not exclude other elements or steps not listed, the indefinite article “a” or “an” does not exclude plural, the term “a plurality of” means two or more, and the term “based on” should be interpreted as “at least partially based on”. The mere fact that certain measures are recited in mutually different dependent claims does not indicate that a combination of these measures cannot be used to get benefit.

What is claimed is:

1. A method for large language model inference, comprising:
performing, by at least one CPU and at least one GPU collaboratively, a plurality of iterations of large language model (LLM) inference, wherein each iteration of the plurality of iterations comprises performing in sequence:
a first task performed by the at least one CPU, the first task comprising determining a plurality of unfinished sequences and latest generated token IDs of the plurality of unfinished sequences;
a second task performed by the at least one CPU, the second task comprising generating a model input based on the latest generated token IDs of the plurality of unfinished sequences;
a third task performed by the at least one GPU, the third task comprising computing, based on the model input, probability distributions for a plurality of next tokens to be generated for the plurality of unfinished sequences;
a fourth task performed by the at least one GPU, the fourth task comprising sampling from the probability distributions for the plurality of next tokens to obtain token IDs for the plurality of next tokens; and
a fifth task performed by the at least one CPU, the fifth task comprising updating, based on the token IDs for the plurality of next tokens, completion states of the plurality of unfinished sequences,
wherein an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.

2. The method according to claim 1, wherein the determining the plurality of unfinished sequences and the latest generated token IDs for the plurality of unfinished sequences comprises:
in response to determining that the plurality of unfinished sequences comprise a target sequence that is determined as an unfinished sequence in a first task of a previous iteration, assigning a placeholder token ID as a latest generated token ID of the target sequence; and
wherein the generating the model input comprises:
forming a first tensor, the first tensor comprising the latest generated token IDs of the plurality of unfinished sequences; and
backfilling, after a target token ID for the target sequence was obtained through sampling in a fourth task of the previous iteration, the placeholder token ID in the first tensor with the target token ID, wherein the model input comprises a backfilled first tensor.

3. The method according to claim 2, wherein the generating the model input further comprises:
forming a second tensor, the second tensor comprising position indexes of the plurality of next tokens in respective sequences, and the model input comprising the second tensor; and
sending the second tensor to the at least one GPU prior to the backfilling.

4. The method according to claim 3, wherein the generating the model input further comprises:
in response to determining that the plurality of unfinished sequences do not comprise any sequence that is determined as an unfinished sequence in the first task of the previous iteration, sending the first tensor to the at least one GPU after the first tensor is formed without backfilling.

5. The method according to claim 1, wherein a first task of an (n+2)^{th} iteration is performed after the fifth task of the n^{th} iteration.

6. The method according to claim 3, wherein the plurality of unfinished sequences comprises a plurality of decoding sequences and a plurality of prefilling sequences,
wherein the latest generated token IDs comprise, for each decoding sequence, a respective latest generated token ID, and the first task further comprises:
determining, for each prefilling sequence, one or more prompt token IDs to be processed in a current iteration, and
wherein the probability distributions for the plurality of next tokens comprise a probability distribution for a next token to be generated for each decoding sequence of the plurality of decoding sequences, and the third task further comprises:
performing, for each prefilling sequence, forward propagation computation on one or more prompt token IDs determined for the prefilling sequence in the first task of the current iteration.

7. The method according to claim 6, wherein the first task further comprises:
determining, for each unfinished sequence of the plurality of unfinished sequences, a sequence state that comprises:
an expected length of the unfinished sequence at an end of a current iteration;
a current length of the unfinished sequence at a start of a current iteration; and
a number of a next token to be generated during a current iteration for a decoding sequence, or a number of prompt token IDs to be used in a current iteration for a prefilling sequence, and
wherein the current length of the unfinished sequence at a start of a current iteration is determined based on an expected length of the unfinished sequence at an end of a most recent prior iteration in which inference was performed for the unfinished sequence.

8. The method according to claim 7, wherein the second tensor is determined based on sequence state of each decoding sequence of the plurality of decoding sequences.

9. The method according to claim 7, wherein the number of a next token to be generated during a current iteration for a decoding sequence is 1, and the number of prompt token IDs to be processed in a current iteration for a prefilling sequence does not exceed a first predetermined number, the first predetermined number being not less than 2.

10. The method according to claim 6, wherein the second task further comprises:
determining sampling metadata for each decoding sequence of the plurality of decoding sequences, the sampling metadata for each decoding sequence being sent to the at least one GPU during performing of the third task,
wherein the sampling from the probability distributions for the plurality of next tokens comprises:
sampling, for each decoding sequence, based on sampling metadata for the decoding sequence and from a probability distribution of a next token to be generated for the decoding sequence, to obtain a token ID for the next token.

11. The method according to claim 6, wherein the at least one GPU corresponds to a plurality of worker processes, and after computing the probability distributions, each worker process holds a probability distribution over a partial vocabulary for all or a portion of the plurality of decoding sequences, wherein the sampling from the probability distributions for the plurality of next tokens comprises:
performing an all-to-all data exchange operation among the plurality of worker processes, such that each worker process holds a probability distribution over a full vocabulary for one or more decoding sequences associated with the worker process;
sampling, on each worker process, from a probability distribution over a full vocabulary for each decoding sequence associated with the worker process, to obtain a token ID for a next token for the decoding sequence; and
gathering sampling results of the plurality of worker processes to obtain token IDs for the plurality of next tokens.

12. The method according to claim 11, wherein the model input further comprises an original index for each decoding sequence of the plurality of decoding sequences, and an index for each decoding sequence within a corresponding worker process is determined by applying a modulo operation to the original index of the decoding sequence with respect to a number of the plurality of worker processes.

13. The method according to claim 11, wherein the fourth task further comprises:
padding the plurality of decoding sequences with one or more placeholder sequences prior to performing the all-to-all data exchange operation, so that a number of sequences after padding is divisible by a number of the plurality of worker processes; and
discarding sampling results for the one or more placeholder sequences after gathering the sampling results of the plurality of worker processes.

14. The method according to claim 11, wherein an identical set of random numbers are pre-generated on each worker process of the plurality of worker processes, and each worker process uses a subset of the identical set of random numbers during the third task and/or the fourth task.

15. The method according to claim 1, wherein the first task further comprises:
determining at least one key-value (KV) cache block to be allocated for each unfinished sequence of the plurality of unfinished sequences; and
obtaining a KV cache block index for the at least one KV cache block, wherein the model input comprises the KV cache block index for each unfinished sequence of the plurality of unfinished sequences.

16. The method according to claim 15, wherein a single KV cache block is capable of accommodating keys and values corresponding to a second predetermined number of tokens, and wherein determining at least one KV cache block to be allocated for each unfinished sequence of the plurality of unfinished sequences comprises:
determining a number of KV cache blocks to be allocated for each unfinished sequence of the plurality of unfinished sequences based on a sequence length of the unfinished sequence and the second predetermined number.

17. An electronic device, comprising:
at least one CPU and at least one GPU;
a memory storing one or more programs configured to be executed by the at least one CPU and at least one GPU, collaboratively, the one or more programs including instructions for performing a plurality of iterations of LLM inference, wherein each iteration of the plurality of iterations comprises performing in sequence:
a first task performed by the at least one CPU, the first task comprising determining a plurality of unfinished sequences and latest generated token IDs of the plurality of unfinished sequences;
a second task performed by the at least one CPU, the second task comprising generating a model input based on the latest generated token IDs of the plurality of unfinished sequences;
a third task performed by the at least one GPU, the third task comprising computing, based on the model input, probability distributions for a plurality of next tokens to be generated for the plurality of unfinished sequences;
a fourth task performed by the at least one GPU, the fourth task comprising sampling from the probability distributions for the plurality of next tokens to obtain token IDs for the plurality of next tokens; and
a fifth task performed by the at least one CPU, the fifth task comprising updating, based on the token IDs for the plurality of next tokens, completion states of the plurality of unfinished sequences,
wherein an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.

18. A non-transient computer-readable storage medium storing one or more programs, the one or more programs comprising instructions, which when executed by at least one CPU and at least one GPU of an electronic device, collaboratively, cause the electronic device to:
perform a plurality of iterations of large language model (LLM) inference, wherein each iteration of the plurality of iterations comprises performing in sequence:
a first task performed by the at least one CPU, the first task comprising determining a plurality of unfinished sequences and latest generated token IDs of the plurality of unfinished sequences;
a second task performed by the at least one CPU, the second task comprising generating a model input based on the latest generated token IDs of the plurality of unfinished sequences;
a third task performed by the at least one GPU, the third task comprising computing, based on the model input, probability distributions for a plurality of next tokens to be generated for the plurality of unfinished sequences;
a fourth task performed by the at least one GPU, the fourth task comprising sampling from the probability distributions for the plurality of next tokens to obtain token IDs for the plurality of next tokens; and
a fifth task performed by the at least one CPU, the fifth task comprising updating, based on the token IDs for the plurality of next tokens, completion states of the plurality of unfinished sequences,
wherein an (n+1)^{th} iteration and an n^{th} iteration are performed asynchronously, a first task and a second task of the (n+1)^{th} iteration are performed in parallel with a third task of the n^{th} iteration, and a third task of the (n+1)^{th} iteration is performed in parallel with a fifth task of the n^{th} iteration.
